(19) United States
(12) Patent Application Publication
(10) Pub. No.: US 2009/0161766 A1
(43) Pub. Date: Jun. 25, 2009

(54) System and Method for Processing Video Content Having Redundant Pixel Values

(75) Inventors: Alexander Bronstein, San Jose, CA (US); Michael Bronstein, Santa Clara, CA (US)

Correspondence Address: Stevens Law Group, 1754 Technology Drive, Suite #226, San Jose, CA, 95110, US

(73) Assignee: Novafora, Inc., Santa Clara, CA (US)

(21) Appl. No.: 11/963,705

(22) Filed: Dec. 21, 2007

(51) Int. Cl. H04N 7/26

(52) U.S. Cl. 375/240.23; 375/E07.076

(57) ABSTRACT

A system and method for processing of video content containing redundant pixels using the picture recombination technique, with one of the main application in video transcoding process. The picture recombination process employs a quality ranking criterion to adaptively select the best region from the co-located regions of redundant pictures as the region for output. An approximation for quality ranking between a decoded picture region and an original picture region has been developed to guide the selection for recombination because the original picture is not available to the transcoder. The quality ranking formula is further modified as a simple linear function depending on the quantization scale, the bit count, and complexity measure of the region.

### BACKGROUND

The invention relates to the field of video processing and, more particularly, to improved transcoding to address redundancy of pixel values in a video sequence that is associated with frame rate conversion.

In the field of video processing, many issues need to be addressed in order to transmit and process video signals to produce a quality video display to observers. Video signals can be regarded as spatio-temporal data, having two spatial and one temporal dimension. These data can be processed spatially, considering individual pictures, or temporally, considering sequences of pictures. Hereinafter, the term picture is used generically referring to both frames (in case of progressive video content) and fields (in case of interlaced content). In temporal (or inter-frame) processing different characteristics that relate to various pictures being transmitted in a video stream are processed. For example, frame dropping and other processes related to a number of pictures are processed in temporal type processing. Spatial (or intra-frame) processing relates to different characteristics, features as well as material content within a picture, such as color, contrast, artifacts and other features that are located within a single picture. Thus, temporal processing relates to processing among a number of pictures, and spatial processing relates to processing the characteristics of a single picture based on material and content located within the particular picture.

Video processing schemes in different applications need to address a variety of issues related to both spatial and temporal characteristics of video data. One such example is video compression which may be composed of, a family of algorithms trying to exploit redundancy in video data in order to represent them more efficiently. Typically, both temporal redundancy (manifested in the similarity of consecutive frames or fields in video) and spatial redundancy (manifested in the similarity of adjacent pixels in a picture in the video) are exploited. Video compression can play an important role in modern video applications, making distribution and storage of video practical. With demand for higher quality video and high definition televisions, these issues become more critical. Ideally, one would like to achieve a minimum distortion in the video with the smallest number of bits required for the representation. In practice, a video encoding algorithm is able to achieve a certain tradeoff between bit rate and distortion, referred to in the art as the rate-distortion curve.

While the main goal of video compression is to achieve the most compact representation of video data with minimal distortion, there are additional factors to be taken into consideration. One such factor is the computational complexity of the video compression process. Solutions must be sensitive to excessive data processing, keeping the amount of data to be processed to a minimum. Also, complicated algorithms that process data within pictures and among various pictures need also to be kept simple enough so as not to overburden processors.

Many factors are taken into account in setting the bit rate, including electric power consumed, resultant quality of the end display, and other factors. Thus, it is preferred that any improved processing techniques address all of the complicated issues related to video processing, while avoiding unnecessary additional burdens on processors that perform the video data processing operations.

Most conventional MPEG-type compression techniques will segment the video sequence into groups of pictures (GOP), where each group of pictures contains a fraction of a second to a few seconds worth of pictures for quick resynchronization or quick searching purposes. Within each group of pictures, the first picture is often compressed by itself, exploiting only the redundancy of adjacent pixels within the picture. Such pictures are known as intra- or I-pictures, and the process of compression thereof is known as intra-prediction. The subsequent pictures are compressed exploiting temporal redundancy by means of motion compensation. This process attempts to construct the current picture from temporally adjacent pictures by displacing the corresponding pixels to repeat as accurately as possible the motion pattern of the depicted objects. Such pictures are referred to in MPEG-type compression standards as predicted pictures. Typically, there exist two types of predicted pictures: P and B. P-pictures are compressed using temporal prediction with reference to a previously processed picture. In a B-picture, the prediction is from two reference pictures, hence the name B- for bi-predicted. The number of B-pictures between a P-picture and its preceding reference picture is typically 0, 1, 2 or 3, although most conventional coding standards allow for a larger number.

The used of the (I, B, P) structure may cause different pictures to have different quality due to the particular picture type (I-, P-, or B-picture) and compression parameters app lied. Tradeoffs between bitrate and distortion are the major considerations in such decisions. Typically, the reference I-picture is compressed with the highest quality, while B-picture not used as reference are compressed with the lowest quality.

Describing the way video compression works, those skilled in the art will understand that, for interlaced video, wherein a picture is decomposed into odd and even lines referred to as fields, an advanced coding system may adaptively select either field-based or frame-based processing. For simplicity of illustration of the invention, frame-based coding is used for discussion herein. However, it will be understood that the concepts can be extended to field-based coding for interlaced material.

While the general intention of video compression is to reduce the redundancy of video data, in many practical situations, an artificial redundancy is created. Such situations often arise due to compatibility of different types of video content and broadcast schemes. For example, a movie film is usually shot at 24 frames per second, while a television displaying the movie is running at 29.97 frames per second. This is typical in the North America and other regions around the world. To further complicate matters, television signals are often broadcast in an interlaced format, in which a frame is displayed as two fields: one corresponding to odd lines of the frame, and the other corresponding to even lines of the frame. The fields are displayed separately at a twice higher rate, creating an illusion of an entire frame displayed 29.97 times per second due to the persistence of the human eye. In order to show a movie in the television format, the movie at 24 frames per second needs to be converted to a frame rate of 29.97 frames per second. Here, the film content needs to be processed using a method known as telecine conversion, or 3:2 pulldown, to match the television format. The frame rate up-conversion is accomplished by rep eating some frames of the lower frame-rate content (that received at 24 frames per second and converted to 29.97 frames per second) in a particular repetition pattern, usually referred to as cadence. The new video processed this way (and containing redundancy due to the telecine process) then undergoes compression at the broadcaster side and is distributed to the end users.

There are also situations where two video materials received at different frame rates need to be mixed together. For example, a computer-generated video containing graphics or text at 29.97 frames per second may be overlaid with film content at 24 frames per second, where the final production is to be shown as a television program. Such content is usually referred to as mixed content and exhibits redundancy not on frame but on pixel level, that is, different regions of the frame can have different redundant patterns.

At the user side, the compressed up-converted video can undergo video decoding and subsequent processing, for the purpose of display or storage. The redundancy of the fields or frames due to the telecine process can be explicitly exploited using a process called inverse-telecine conversion. The inverse-telecine detects the existence of cadence, removes the redundant fields or frames, and re-orders the remaining fields or frames properly. For non-interlaced (progressive) content, inverse telecine can be simply achieved by frame dropping. One example of this process is described in U.S. Pat. No. 5,929,902 of Kwok, which describes a method and device for inverse telecine processing that takes into consideration the 3:2-pulldown cadence for subsequent digital video compression. U.S. patent application Ser. No. 11/537,505, of Wredenhagen et al., describes a system and method for detecting telecine in the presence of static pattern overlay, where the static pattern is generated at the up-converted frame rate. U.S. patent application Ser. No. 11/343,119, of Jia et al., describes a method for detecting telecine in the presence of moving interlaced text overlay, where the moving interlaced text is generated at the up-converted frame rate.

In some applications, a compressed video is subsequently decoded and re-encoded into another compressed video format for retransmission, subsequent distribution or storage. The process is known as transcoding in the field of television technology. For example, a movie being delivered on a digital cable system using the standard MPEG-2 compression may be streamed for internet applications using the advanced H.264 compression at a much lower bit rate.

A video transcoder can be simplistically represented as consisting of a video decoder, video processor and video encoder. Since the output of the decoder will be a video containing redundancy due to telecine conversion, the efficiency of the subsequent encoding will be affected, resulting in higher bit rate. Thus, the reduction of the redundancy has a significant effect on the resulting bitrate, therefore, the use of inverse telecine techniques carried out by the video processor as an intermediate stage between decoding and encoding is important. However, there are many video transcoders that do not address pulldown. As a result, when a video containing cadence is compressed by such digital video encoder, the resulting bit rate may be unnecessarily increased. In an ideal system, the redundant frame may be compressed by a compression technique incorporating temporal prediction such as the MPEG-2 coding standard. When the temporal prediction technique operates on the set of repeated frames, it should theoretically produce near perfect prediction and result in substantially zero differences between a frame and its subsequent redundant frame. Again in theory, the redundant frame should consume no substantial bit rate except for a small amount of overhead information, indicating merely that a redundant frame exists.

In practice, due to different limitations stemming both from specific compression standards and their implementation, it is often impossible for the encoder to eliminate the redundancy due to telecine conversion. For example, if the encoder uses a fixed GOP structure, some redundant frames may be forcefully transmitted as I-frames requiring a substantial bitrate, instead of being predicted and transmitted as P- or B-frames requiring a very small amount of bits.

In practice, the redundant frame usually is not an exact copy of the previous frame because of the nature of the film scanning process, which introduces some degree of variation during the scan process. Furthermore, in practical situations, the compression techniques used at the broadcaster side introduce artifacts, which may make two equal redundant frames not completely identical. As a result, the video decoded at the user side does not contain repeating identical frames but rather similar frames.

Depending on the compression scheme used, multiple instances of the same frame can exhibit different artifacts and in general, differ in their quality. For example, if a frame A is repeated as A′ and A″ by the telecine process and frames A, A′ and A″ happen to be compressed as I-, B-, and B-frames respectively, then frame A processed as an I-frame may have a higher quality than the subsequent A′ and A″ processed as B-frames.

Moreover, the picture quality of a compressed frame is usually not uniform over the entire frame. Often, a compression system is designed to fit the compressed video into a given target bit rate for transmission or storage. In order to meet the target bit rate, a technique called bit rate control is implemented by adjusting coding parameters to regulate the resulting bit rate. The adjustment can be done on the basis of a smaller data unit, called a macroblock (typically, consisting of a 16×16 block of pixels), instead of on the basis of a whole frame. Since different coding parameters may be applied to the macroblocks of a frame, different macroblocks of a frame may show different quality. For P-frames and B-frames, temporal prediction may fail to produce a reasonable prediction based on reference picture. For areas where temporal prediction fails, a compression method reverting to intra-prediction may produce better quality. Therefore, intra-predicted macroblocks may app ear in both the P-frame and B-frame, adding yet another variable to quality variations within a frame.

The frames may have quality variations due to the particular coding parameters applied during the encoding process. The quality variations may occur from region to region in a frame depending on these parameters. Thus, again, redundant data can be available with different artifact and different distortions. Conventional methods of inverse telecine, (e.g. based on frame dropping) used to remove redundant frames do not address such quality differences.

Finally, in the case of mixed content, the redundancy may exist at the level of pixels or regions within frames rather than at the level of entire frames. For example, a part of the frame originating from the film content may have redundant patterns, while a computer graphics overlay generated at 29.97 frames per second will not. In this case, frame dropping cannot be used, and the redundancy will remain, increasing the bitrate of the transcoded video.

Thus, there exists a need for improved processing systems and methods to better address issues of redundant data. As will be seen, the invention provides a novel and improved system that better addresses redundant video data.

### SUMMARY

The present invention proposes a method and a system for the reduction of redundancy in video content. In the video transcoding application, the invention overcomes the issue of unnecessary bit rate increase associated with redundant data in the decoded video. One objective of the invention is to minimize the extra bits required for the redundant frames by combining pixels from redundant frames into one frame. Another objective of the invention is to retain the best possible visual quality by adaptively selecting the best pixels on a regional basis from the redundant frames. The region may be a pixel or group of pixels, a macroblock or other predefined boundary. In one exemplary implementation, during the transcoding process, the incoming bitstream is decoded and a cadence detector is used to identify redundant frames. The invention employs a novel method of redundant pixels composition that composes a single output frame from redundant frames on the regional basis by selecting the macroblock with best visual quality from co-located pixels of redundant frames.

In another embodiment, the invention provides the ability to rank quality as a measurement of visual quality for selecting the best macroblock for the purpose of optimal frame composition. In one embodiment of the invention, the optimal frame composition uses a quality ranking that is inversely related to the distortion measure between the macroblock of a decoded frame and the macroblock of the original frame. Furthermore, in practice, the original frame is not available to the transcoder and the distortion should be estimated based on decoded frames without the original frame. One embodiment of the current invention utilizes a distortion estimation that is dependent on the quantization scale, the number of produced bits, and complexity measure. The complexity measure is a function of pixel intensity variance and the type of picture (I, P, or B frame) which is known in the art. The quantization scale, the number of produced bits, and frame type are coding parameters that are part of the information in the compressed bitstream.

A system configured according to the invention may produce a superior picture quality as compared to prior art that employs frame dropping. These and other advantages of a system or method configured according to the invention may be appreciated from a review of the following detailed description of the invention, along with the accompanying figures in which like reference numerals refer to like parts throughout.

### BRIEF DESCRIPTION OF THE DRAWINGS

FIG. 1 illustrates the conversion of 23.976 frames/sec film content to interlaced 29.97 frames/sec (59.94 fields/sec) TV content.

FIG. 2 illustrates the conversion of 23.976 frames/sec film content to progressive 59.94 frames/sec TV content.

FIG. 3 illustrates the conversion of mixed content containing 23.976 frames/sec film content and 29.97 frames/sec overlay content into progressive 59.94 frames/sec TV content.

FIG. 4 illustrates a typical group of pictures structure used in MPEG-2.

FIG. 5 illustrates MPEG-2 encoding of video with redundant frames with a fixed GOP structure, where a redundant frame is forced to be encoded as an I-frame.

FIG. 6 illustrates a typical system for transcoding of film content; where cadence detection is used to identify redundant frames and drop them.

FIG. 7 illustrates transcoding of film content that embodies the inventive recombination device.

FIG. 8 A-E illustrates an optimal redundancy removal process.

FIG. 9 illustrates the process of redundant content recombination configured according to the invention.

FIG. 10 illustrates an embodiment of the recombination using macroblock-based recombination: composition of frame from macroblocks of redundant frames.

FIGS. 11A-C illustrate an adaptive redundancy removal process.

### DETAILED DESCRIPTION

As discussed briefly in the background, in situations where a video source with certain bitrate is used in a system having a different frame rate, the frame rate of the video source needs to be converted to match the frame rate of the display. Further background will be discussed to best describe the invention. For example, assume that film content usually is shot at 24 frames per second (fps) while a television runs at 29.97 fps (the North America NTSC standard). In order to show a film content in the television format, the film at 24 fps has to be converted to 29.97 fps. Furthermore, one of the standard television signal formats is designed to display a frame as two interlaced time sequential fields (odd lines and even lines of the frame) to increase the apparent temporal picture rate for reducing flickering.

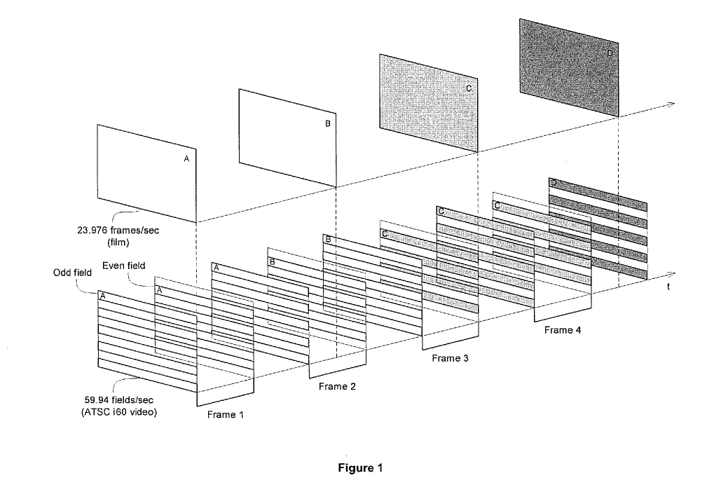

A known practice in converting movie film content into a digital format suitable for broadcast and display on television is called telecine or 3:2 pulldown. This frame rate conversion process involves scanning movie picture frames in a 3:2 cadence pattern, i.e., converting the first picture of each picture pair into three television fields and converting the second picture of the picture pair into two television fields, as shown in FIG. 1. In this case, four film frames result in eight corresponding fields (four frames) of interlaced NTSC video, and the 3:2 pattern is seen in converted television fields. When the converted television fields are displayed at the rate of 59.94 fields per second, the effective frame rate for the corresponding movie film is 23.976 fps.

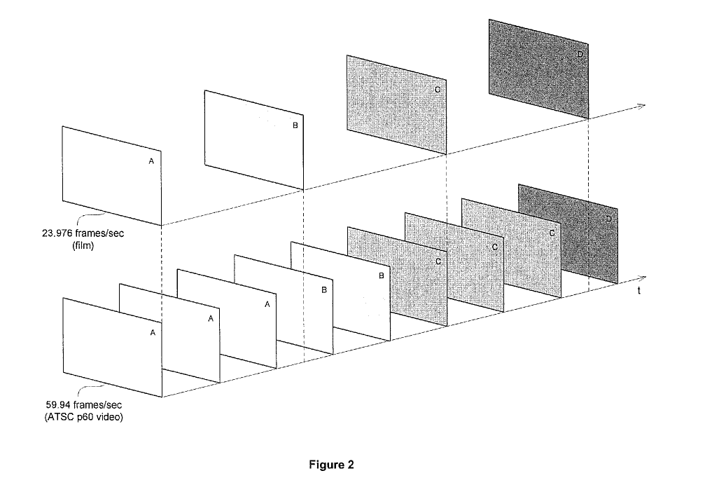

Due to the advancement in display technology, progressive display systems are gaining popularity. Instead of using a frame rate of 59.94 fields per second, the newer progressive TV sets can support 59.94 frames per second for NTSC standard. FIG. 2 shows the conversion of 23.976 fps film content into an NTSC video sequence at the rate of 59.94 fps (often referred to as p60, the letter “p” indicating progressive frames, and 60 being the closest integer frame rate). In this case, four film frames corresponds to eight frames of NTSC video, which results in a rep eating 3:2 pattern of redundant frames (AAABB).

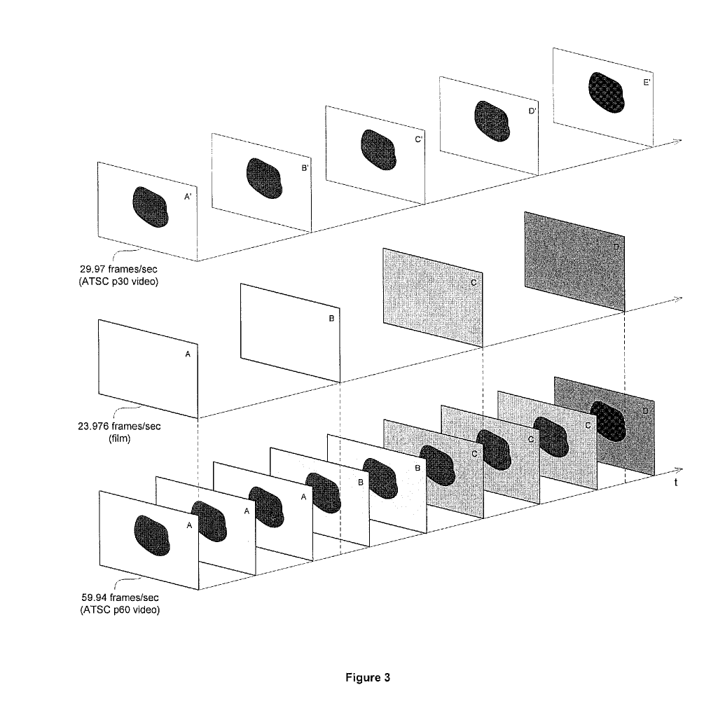

In some cases, the content can exhibit “mixed” patterns such as combined film and TV originated materials. Such a situation is common in content combining motion picture and computer graphics. An example depicted in FIG. 3 shows a case in which computer-generated content at 29.97 fps is overlaid onto film content at 23.976 fps and then converted into 59.94 fps NTSC video. In this case, parts of the picture show one 3:2 pattern (AAABB) and other parts corresponding to the video overlay another pattern (A′A′B′B′). Besides the redundancy patterns, other frame rates and cadences can be encountered in practical applications.

Digital video compression has developed in recent years as a bandwidth effective means for video transmission or storage. For example, MPEG-2 has been widely adopted as the standard for television broadcast and DVD disk. Other emerging compression standards such as H.264 are also gaining more support. While the telecine process increases the apparent frame rate of the video material originated from movie film, it adds redundant fields or frames into the converted television signal. The redundancy in the converted television signal may unnecessarily increase the bandwidth if it is not properly treated when the converted material undergoes digital video compression.

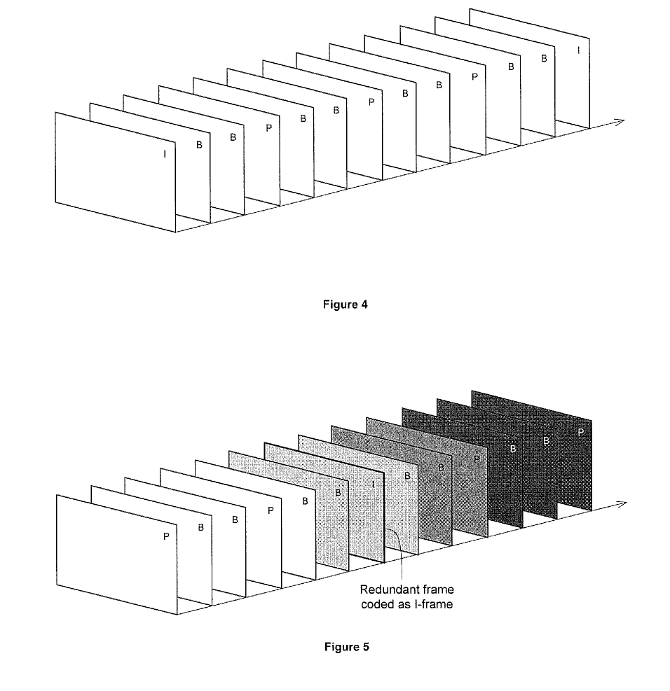

The MPEG-2 standard exploits the temp oral and spatial redundancy and utilizes entropy coding for compact data representation to achieve a high degree of compression. In MPEG-2 compression, a picture (hereinafter, assumed to be a frame for the simplicity of discussion) can be compressed into one of the following three types: intra-coded frame (I-frame), predictive-coded frame (P-frame), and bi-directionally-predictive-coded frames (B-frame). The P-frame is coded depending on a previously coded I-frame or P-frame, called a reference frame. The B-frame is coded depending on two neighboring and previously coded pictures that are either an (I-frame, P-frame) pair, or both P-frames. Very often, the MPEG-2 coding divides a sequence into a Group of Pictures (GOP) consisting of a leading I-frame and multiple P-frames and B-frames. Depending on the particular system design, there may be a number of intervening B-frames or no B-frame at all between a P-frame and the preceding I-frame or P-frame on which it depends. A sample structure of I-, P-, and B-frames in a video sequence is shown in FIG. 4, where the GOP contains 12 frames and there are 2 B-frames between a P-frame and its preceding reference frame.

In typical operation, an I-frame is encoded such that it can be reconstructed independently of preceding or following frames. Each input frame is divided into 8×8 blocks of pixels. A discrete cosine transform (DCT) is applied on each of the blocks, producing an 8×8 matrix of transform coefficients. The two-dimensional transform coefficients are converted into a one-dimensional signal by traversing the two-dimensional coefficients through a zigzag pattern. The one-dimensional coefficients are then quantized, which allows reducing significantly the amount of information required to represent the image. This introduces artifacts into the frame, which are usually significant enough to be noticed. The quantized coefficients are then coded using entropy coding.

P-frames allow for exploiting of the temporal redundancy of video, where the temporally close frames are usually similar, except for the areas involved in object movement. During P-frame encoding, the MPEG-2 encoder tries to predict the frame from another nearby frame (called the reference frame) by the operation of motion compensation. For this purpose, the frame is divided into squares of 16×16 pixels, called macroblocks. For each macroblock, the best matching macroblock is searched in the reference frame by a process called motion estimation. The corresponding offset of the macroblock is called motion vector. The difference between the motion predicted frame and the actual P-frame is called the residual. The P-frame is encoded by compressing the residual (similarly as performed on the I-frame) and the motion vectors.

A B-frame is encoded similarly to a P-frame, where the difference is that it can be predicted from two reference frames. I-frames and P-frames are called reference frames as they are used as references for motion prediction. B-frames are never used as references. Frames of different types are arranged into a group of pictures (GOP), which has a typical structure shown in FIG. 4.

When the telecine converted video sequence is fed to a digital video encoder, such as an MPEG-2 encoder, the redundant fields or frames may result in a high data rate if the encoder compresses the converted sequence without taking into consideration the redundancy. A well-designed video encoder may process the input video sequence to detect the presence of a telecine converted sequence. The encoder will eliminate the redundant fields or frames when the telecine converted sequence is detected and the redundant fields or frames are identified. A prior art method that incorporates telecine detection in an encoder system is described in the U.S. Pat. No. 4,313,135. Although such a digital video encoder exists, not every video encoder supports the telecine detection feature, and compressed video often contains redundant fields or frames.

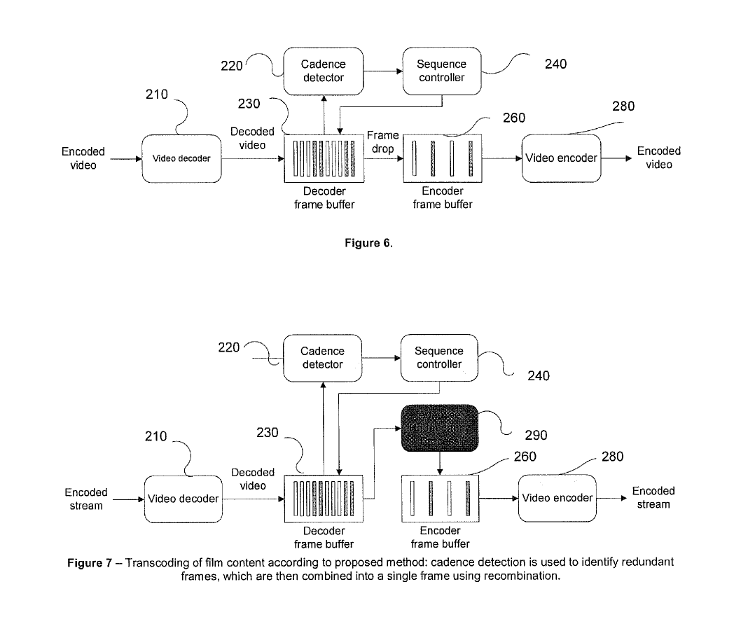

When a telecine converted video sequence is compressed using an MPEG-2 encoder, the redundancy of repeated fields or frames may significantly reduce the compression efficiency. Theoretically, two identical fields or frames can be represented efficiently, since one of them can be predicted with zero error from the other one. However, since the GOP structure in MPEG-2 used for broadcast applications is usually rigid, it is possible that redundant fields or frames are encoded as I-frames. FIG. 5 shows a possible encoding of redundant frames, in which three repeated frames are coded as BIB (thus one of the redundant frames forcefully encoded as I-frame with significant amount of bits), whereas theoretically all of them could be predicted, for example, forming a sequence PPP represented with a few bits.

As a result of compression, redundant frames are no longer identical, since compression artifacts may be different in each of them. Typically, I-frames have the least distortion, since they are used as references. B-frames have the largest distortion since they are not used as reference frames. The frame type being used for each frame may serve as an indication of general quality of the frame. Therefore, redundant pixels used for producing a combined frame may be based on the frame type used by the video encoder. An even more accurate quality estimate may be achieved by taking into account of both the quantization scale of each macroblock and the frame type. In the art of video coding, the distortion has been parameterized separately as a function of quantization scale for I, P and B frames. Consequently, the quality estimate based on both the quantization scale of each macroblock and the frame type will be more accurate.

The problem of redundant content is especially acute in video transcoding applications. Video transcoding is a process that converts a compressed video processed by a first compression technique with a first set of compression parameters into another compressed video processed by a second compression technique with a second set of parameters. The first compression technique may be the same as the second compression technique. Video transcoding is often used where a compressed video is transmitted, distributed or stored at a different bit rate, or where a compressed video is retransmitted using a different coding standard. For example, movie content in DVD format (compressed using the MPEG-2 standard) may be transcoded for streaming over the Internet at a much lower bit rate using MPEG-4 or other high-efficiency coding techniques. As another example, a compressed video broadcast over the air in the MPEG-2 format may be stored to a local digital medium using the advanced, more compression-efficient H.264 format. In the transcoding process, the first compressed video is decompressed into an uncompressed format, and a second compression process is applied to the uncompressed video to form a second compressed video. In a simplified way, a transcoder can be thought of as consisting of a video decoder performing decoding processes, a processor performing some processing on the decoded video, and a video encoder encoding the result.

As mentioned earlier, a compressed video may contain redundant frames and the redundancy may increase the required bit rate if the video encoder does not take care of the redundancy carefully. When such compressed video is transcoded, the bit rate of the second compressed video will be unnecessarily high. One of the ways to increase the encoding efficiency is by removing repeating patterns of redundant frames, such as those resulting from telecine conversion, in a sense, trying to reverse the telecine process. As a result, it is possible to lower the video frame rate back to the native film frame rate without visually affecting the content.

An example of a transcoding system taking advantage of such a redundancy is shown in FIG. 6. Such a system includes a frame buffer in which the decoded frames are stored. A cadence detection algorithm operates on the content of the decoded frame buffer, detecting redundant frame patterns. The information about redundant frames is used by the sequence controller, which drops redundant frames. For example, if the decoder frame buffer contains frames A1A2A3B1B2, and the cadence detector finds that frames A1, A2 and A3 are redundant, only one of these frames (say, A1) will be left and the others (A2 and A3) will be dropped.

The frame dropping approach does not take into consideration the fact that, due to compression artifacts, some of the redundant frames may be better (in terms of visual quality) and some worse. Moreover, in many cases, coding parameters may be adjusted according to bit rate control, as certain parts of frame may be better in one frame, while other parts may be better in another frame. Therefore, in the previous example, instead of retaining A1 and dropping A2 and A3, a representative picture A′ with superior quality may be created by composing A′ by adaptively selecting best quality pixels from corresponding areas among A1, A2 and A3.

One embodiment of the invention is a transcoding system having the inventive adaptive Redundancy Removal process as shown in FIG. 7. The decoded video from Video Decoder 210 is stored in the Decoder Frame Buffer 230. A Cadence Detector 220 examines the video stored in the Decoder Frame Buffer 230 for any cadence pattern that may exist in the decoder video. The Sequence Controller 240 will only label the repeating frames for further processing by the adaptive redundancy removal process 290 instead of dropping the redundant frame as is done in the prior art. The Adaptive redundancy removal process 290 creates a single frame composed of the pixels of the redundant frames, which is optimal in terms of visual quality. According to the invention, frame composition may be used instead of frame dropping in transcoding.

According to the invention, a novel frame composition process may be applied to regions within frames, where a region may be the entire frame, one or more macroblocks, blocks of other size, a single pixel, or a group of pixels. In the following, the index k refers to regions and the kth region of the nth frame is denoted as Aₖⁿ. For each set of co-located regions across the redundant frames, the inventive frame composition process selects the region from the redundant frame that has the best ranking value as the region for the output frame. The ranking value can be the visual quality, distortion measurement, the rate-distortion function, or any other meaningful performance or quality measurement.

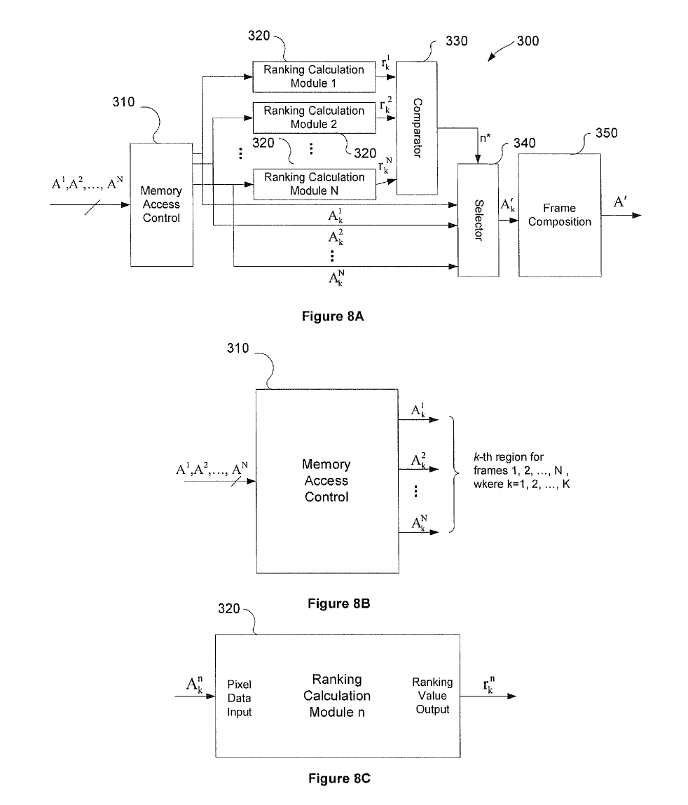

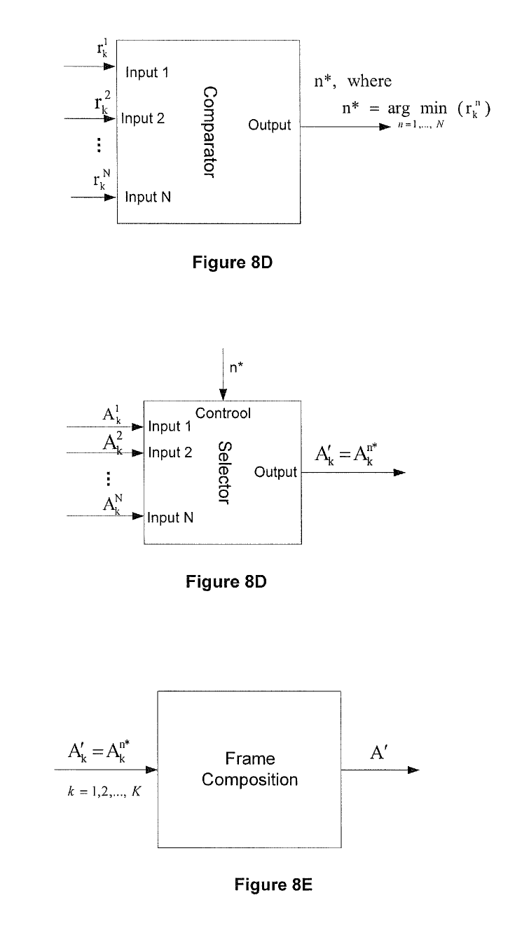

FIG. 8 describes a redundancy removal process 300 according to one embodiment of the invention. The Memory Access Control 310 accepts the redundant frames consisting of frames A¹, A², . . . , A^{N} as inputs, partitions each frame into regions, and outputs co-located regions, Aₖ¹, . . . , Aₖ^{N} for all frames. The regions partitioned by the Memory Access Control 310 can be either non-overlapping or overlapping. The Ranking Calculation Modules 320 compute the corresponding Ranking Values, rₖ¹, . . . , rₖ^{N} for the co-located regions Aₖ¹, . . . , Aₖ^{N}. The ranking criterion may be a quality measurement, a distortion measurement or a more sophisticated measurement. The quality measurement is used as an example for the Ranking Calculation Module 320, where the quality measurement is negatively related to the distortion measurement, d(Aₖⁿ,Aₖ), where Aₖ is the pixel data of the original frame for the kth region. The Comparator module 330 compares the ranking values, rₖ¹, . . . , rₖ^{N} and outputs an index n*, where

$${n}^{*} = {arg min}_{n = 1 , … , N} d ( {A}_{k}^{n} , {A}_{k} )$$

The Selection block 340 outputs A′ₖ corresponding to the region k with the highest quality rank, i.e.,

A′ₖ=Aₖⁿ*.

The Frame Composition module 350 accepts the best quality region A′ₖ outputted from the Selector 340 and composes the output frame by placing picture regions A′ₖ in their respective locations. If the regions are originally partitioned in an overlapped fashion, the overlapped areas have to be properly scaled to form a correct reconstruction.

While quality ranking has been used in the embodiment as a criterion to select from the co-located regions for the desired output region, it will be apparent to a skilled person in the art that the output region may be selected based on other criterion. For example, the cost function that takes into consideration of both bits produced and the corresponding distortion may be used as the criterion to select the desired region. The cost function depending on both produced bits and corresponding distortion is popularly used in many advanced video coding standards. Such a cost function based approach is well known in the field of video coding as Rate-Distortion (R-D) Optimization. Such R-D based optimization has been adopted in the H.264 international coding standard and is suited for the ranking criterion.

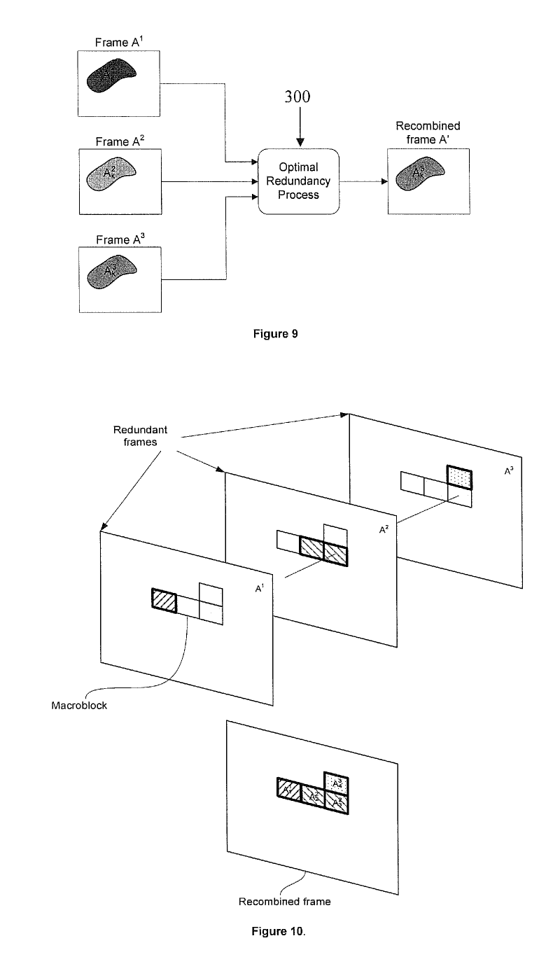

FIG. 9 illustrates an example of the Recombination that accepts three frames having redundant pixel values. The input to the Optimal Redundancy Removal Process 300 are the decoded redundant frames, denoted as A¹, A² and A³ and their corresponding metadata, consisting of all the parameters necessary to compute the ranking. The output of the Optimal Redundancy Removal Process is the resulting recombined frame A′. An arbitrary-shaped region from each frame is shown in FIG. 9 to illustrate that the invention is not necessarily restricted to macroblocks. The metadata are auxiliary data that are used by the decode to assist or control the reconstruction of compressed pixel data. Examples of metadata in the MPEG-2 standard include the frame type, quantization scale, macroblock type, and number of bits used to encode each macroblock.

Assuming that the redundant data arise from the source frame A, the redundant frames A¹, A² and A³ will be almost identical to A, with minor discrepancies due to lossy compression. One of the objectives of the Optimal Redundancy Removal Process 300 is to create a single frame A′ with best possible visual quality out of A¹, A² and A³. Ideally, the recombined A′ should be as close to A as possible. Thus, the optimal recombination is achieved by selecting the pixels of those frames which are the closest (as to some distortion function d) to A, i.e., the quality criterion used of the ranking calculation module 320 (FIG. 8A) is inversely proportional to the distortion, e.g. rₖⁿ=−d(Aₖⁿ, Aₖ). In practice, since A is unknown, such a recombination relying on actual distortion is impossible. Instead, according to the invention, the predicted distortion, derived using some metadata, is employed as a quality measurement rather than the actual distortion.

According to the invention, instead of pixel-wise recombination, region-wise recombination may be used. In MPEG-compressed video, a natural selection for a region is a macroblock (a block of 16×16 pixels), which is used as a data unit for processing. Frame composition can therefore be carried out on a macroblock basis, such that the kth macroblock in the new frame A′ is composed of the collocated macroblocks of frames A¹, A² and A³ as shown in FIG. 10. FIG. 10 illustrates an example that the Optimal Redundancy Removal Process selects output for macroblock A₁ from frame A¹, selects A₂ and A₃ from A² and selects A₄ from A³. In this embodiment, where the data unit of macroblock is used for the region to perform recombination, it will be apparent to a person skilled in the art that other data units can be used to achieve the objective of optimal recombination.

Though the actual distortion of A¹, A² and A³ with respect to A (the original data) is unknown because the original frame A is not available to the Recombination Process, it can be inferred from encoding parameters. Due to the MPEG encoding process, quantization is performed on a macroblock basis. A smaller quantization scale, i.e., a smaller quantization step size, will result in smaller quantization errors and consequently results in higher visual quality. Therefore it is possible to use data such as that based on, for example, the quantization scale as an indication of distortion in the absence of the original picture data. In one embodiment of the optimal Redundancy Process, the quantization scale is utilized to derive the estimated quality ranking. It is known in the art that there is a direct relation of distortion on the quantization scale, such that a larger quantization scale results in a larger distortion. Therefore the quantization scale can be used to select the highest quality redundant macroblocks as those of the smallest quantization scale.

The optimal Redundancy Removal Process 300 uses decoded frames containing redundancy frames. The quality measurement or distortion measure is computed between a decoded frame and an original frame. Nevertheless, in the intended transcoding application, the original frame is not available. Therefore, the quality or distortion measurement needs to be estimated based on information only available at the transcoder. The transcoder receives a compressed bitstream produced by a first encoder. The first encoding process takes the original macroblock Aₖ and a set of encoding parameters (such as quantization scale q, frame type, etc.), denoted here by θₖⁿ, and produces a bitstream consisting of bₖⁿ bits. When the bitstream is decoded, a macroblock Aₖⁿ is obtained.

The values of θₖⁿ, bₖⁿ and the decoded macroblock Aₖⁿ are known. The distortion is d(Aₖⁿ, Aₖ). In order to estimate the distortion, a model relating the distortion, encoder parameters and the number of bits produced is provided by the invention. It is known in the art that bit production can be approximated by a mathematical model for a given set of encoding parameters. Therefore, for a given bit production \hat{b}(θ), the distortion can be estimated as

$$d ( {A}_{k}^{n} , {A}_{k} ) \approx d ( {A}_{k}^{n} , {arg min}_{A} \vert \hat{b} ( {θ}_{k}^{n} ) - {b}_{k}^{n} \vert )$$

In practice, an explicit relation is advantageous. In one embodiment of the invention, in the recombination process, an explicit relation is used for computing the quality ranking. The distortion is directly proportional to the quantization scale q, inversely proportional to the number of bits, and directly proportional to the complexity of the data (e.g., if the texture in the macroblock is rich, the distortion at a fixed q and b will be larger). Therefore, an approximation of explicit relation is a linear model,

\hat{d}(Aₖⁿ,Aₖ)=α₁+α₂qₖⁿα₃bₖⁿ+α₄c(Aₖ),

where c(Aₖ) is a complexity measure (e.g. the variance of the luma pixels for an I-frame or the motion difference between the current and the reference frame for a P-frame), and α₁, . . . , α₄ are some unknown parameters, found by an offline regression process. Since Aₖ is unknown, using the similarity Aₖ≈Aₖⁿ, the complexity can be approximated by c(Aₖ)≈c(Aₖⁿ). Therefore, the distortion between a decoded region Aₖⁿ and an original region Aₖ can be estimated as:

\hat{d}(Aₖⁿ,Aₖ)≈α₁+α₂qₖⁿ+α₃bₖⁿ+α₄c(Aₖⁿ),

where the approximate distortion is a function independent of original picture data. In other words, the distortion may be estimated based solely on decoded picture data and received metadata.

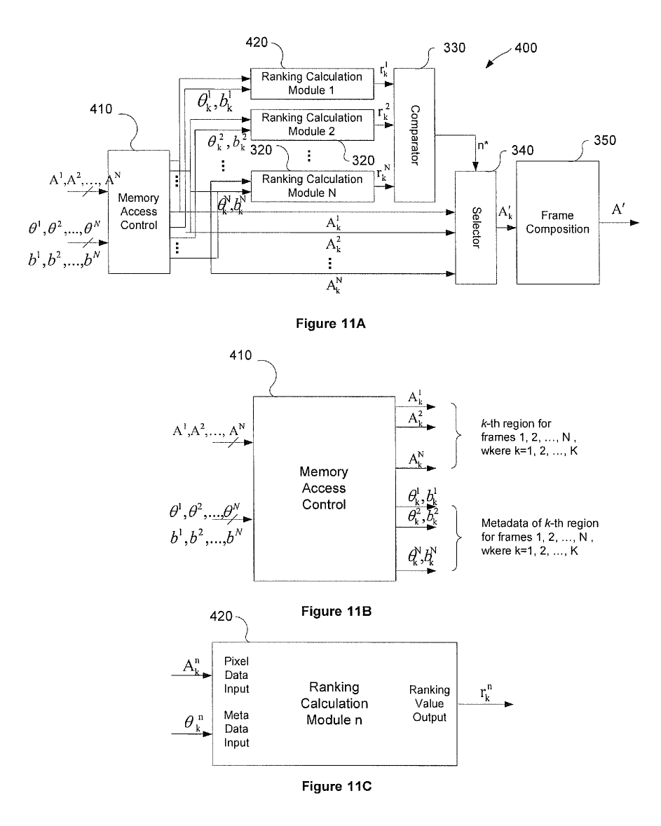

Another variation of the optimal Redundancy Removal Process 400 is shown in FIG. 11. The Memory Access Control 410 accepts the redundant frames consisting of frames A¹, A², . . . , A^{N} and corresponding metadata θₖ¹, θₖ², . . . , θₖ^{N} and bₖ¹, bₖ², . . . , bₖ^{N} as inputs, partitions each frame into regions, and outputs co-located regions, Aₖ¹, . . . , Aₖ^{N} for all frames. The Ranking Calculation Modules 420 compute the corresponding Ranking Values, rₖ¹, . . . , rₖ^{N} for the co-located regions Aₖ¹, . . . , Aₖ^{N} based on the decoded picture data, coding parameters and corresponding bit count. The Ranking criterion can be a quality measurement, a distortion measurement or a more sophisticated measurement such as rate-distortion. The quality measurement is used as an example for the Ranking Calculation Module, where the quality measurement is negatively related to the estimated distortion measurement, \hat{d}(Aₖⁿ,Aₖ), for the kth region, which is a function of decoded picture data, coding parameters, and bit count. The remaining processing of the Adaptive Redundancy Removal Process using distortion estimation is the same as that of the Optimal Redundancy Removal Process.

For color video, the picture data is usually represented in color components known as luminance (or luma) and chrominance (or chroma). The luminance signal is usually in full spatial resolution and the chrominance is in reduced resolution. Recombination of chrominance (chroma) pixels can be performed separately from the luminance (luma) pixels, using the same mechanism.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The apparatus and method include a method and system for improved video processing with a novel approach to handling redundant pixel values. Although this embodiment is described and illustrated in the context of devices, systems and related methods of processing video data, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims and their equivalents.

1. A method comprising:
providing an input sequence of video pictures that each include pixel values;
determining whether at least two pictures contain redundant pixels; and
producing an output sequence of combined pictures by combining redundant pixel values.

2. A method according to claim 1, where the pictures in the input sequence are frames.

3. A method according to claim 1, where the pictures in the input sequence are fields.

4. A method according to claim 1, where the pictures in the output sequence are frames.

5. A method according to claim 1, where the pictures in the output sequence are fields.

6. A method according to claim 1, where the pictures in the input sequence are fields and the pictures in the output sequence are frames, and the process of producing an output sequence of combined pictures is combined with deinterlacing.

7. A method of claim 1, wherein the input sequence of video pictures is obtained by decoding a video sequence coded by means of a video decoder.

8. The method of claim 1, wherein the step of determining whether at least two pictures contain redundant pixels is performed by means of cadence detection.

9. The method of claim 1, wherein the step of determining whether at least two pictures contain redundant pixels includes comparing corresponding pixel values of each picture.

10. The method of claim 1, wherein the step of determining whether at least two pictures contain redundant pixels includes comparing corresponding pixel values of each picture, producing a redundancy value, and comparing the redundancy value to a predetermined threshold value, wherein the pixels are determined to be redundant if the difference between the redundancy value and the threshold value is within a predetermined range.

11. The method of claim 9, wherein the step of whether at least two pictures contain redundant pixels includes comparing corresponding luminance values of corresponding pixel values of each picture, wherein if the difference between the luminance values are within a predetermined threshold, the pixels are deemed redundant.

12. The method of claim 1, wherein the step of producing a combined picture by combining pixel values of the redundant pictures includes combining pixel values located in separate regions of the pictures being combined, wherein the regions are at least one of a pixel, a group of pixels, a rectangular block of pixels, a macroblock, and a plurality of macroblocks.

13. The method of claim 1, wherein the step of producing a combined picture is performed by combining blocks of pixels from the redundant pictures.

14. The method of claim 13, wherein blocks of pixels used for combination are macroblocks used by the video codec.

15. The method of claim 1, wherein the input pictures include corresponding metadata, wherein the step of producing a combined picture is performed by combining pixels from the redundant pictures based on the metadata values.

16. The method of claim 15, wherein the metadata values are encoding parameters of a picture used by the video codec.

17. The method of claim 16, wherein the encoding parameters include the picture type, quantization scale, macroblock type, number of bits required to encode each macroblock.

18. The method of claim 15, wherein the metadata values include the quantization scale and the number of bits used in each macroblock, wherein pixel values are chosen from each redundant macroblock for use in producing a combined picture based on the corresponding quantization scale and the number of bits.

19. The method of claim 15, where the metadata further includes the picture type, and the combined picture is obtained by a hierarchical decision process, as follows:
pixels in I-picture are p referred over pixels in P-picture;
pixels in P-picture are preferred over pixels in B-picture;
If two pictures of the same type are present, pixels are selected according to claim 13.

20. The method of claim 18, wherein pixel values from each redundant macroblock with the smallest quantization scale among the corresponding redundant pixels are chosen from each picture for use in producing a combined picture.

21. The method of claim 15, wherein the metadata values include the picture type of each picture, wherein pixel values are chosen from the redundant pixels in each picture for use in producing a combined picture based on their picture type.

22. The method of claim 15, wherein the metadata values include the quantization scale of each macroblock and the picture type of each picture, wherein pixel values are chosen from the redundant pixels in each picture for use in producing a combined picture based on include the quantization scale and their picture type.

23. The method of claim 20, wherein a the parameters of choosing which pixel values to include in the combined picture are determined by a hierarchy of logic, wherein certain pixel values from the redundant pictures are chosen above others for use in the combined picture based on their picture type.

24. The method of claim 15, wherein the metadata values in each picture include the values of the distortion in the pixel values in this picture introduced by the video codec, wherein pixel values are chosen from the redundant pixels for use in producing a combined picture based on their distortion.

25. The method of claim 24, where the distortion map is provided by the encoder.

26. The method of claim 24, where the distortion is the PSNR.

27. The method of claim 23, wherein the distortion is estimated according to the encoding parameters θ and clues c extracted from the pixels according to the formula
d≈\hat{d}(θ,c)

28. The method of claim 27, wherein the distortion estimate is computed for each macroblock.

29. The method of claim 28, wherein the distortion for macroblock k is estimated by the formula:
\hat{d}ₖ=α₁+α₂qₖⁿ+α₃bₖⁿ+α₄c(Aₖ),
where Aₖ are the pixels of macroblock k, c(Aₖ) is a macroblock complexity measure, qₖ is the macroblock quantization scale, and α₁, . . . , α₄ are model parameters.

30. The method of claim 29, wherein the macroblock complexity measure is proportional to the variance of the luma pixels in the macroblock for an I-picture, and the motion difference between the collocated macroblocks in the current and the reference picture for a P-picture.

31. The method of claim 28, wherein the distortion estimator for macroblock k has the form
$${\hat{d}}_{k} = d ( {A}_{k} , {arg min}_{A} \vert \hat{b} ( {θ}_{k} ) - {b}_{k} \vert ) ,$$
where Aₖ are the pixels of macroblock k, θₖ are the corresponding encoder parameters, bₖ is the amount of bits used to encode the macroblock, and \hat{b}ₖ is an estimator of the amount of bits used to encode the macroblock.

32. A method of claim 31, wherein the estimated amount of bits used to encode the macroblock is computed according to the formula
\hat{b}ₖ=β₁+β₂qₖ⁻¹+β₃qₖ⁻²
where qₖ is the macroblock quantization scale, and β₁, . . . , β₃ are model parameters.

33. The method of claim 1, wherein the step of providing a sequence of video pictures is received from at least one of interlaced video and progressive video.
